(19) United States
(12) Patent Application Publication
(10) Pub. No.: US 2007/0030772 A1
(43) Pub. Date: Feb. 8, 2007

(54) Optical disc apparatus

(76) Inventor: Masakatsu Matsui, Kanagawa (JP)

Correspondence Address: DICKSTEIN SHAPIRO LLP, 1825 EYE STREET NW, Washington, DC, 20006-5403, US

(21) Appl. No.: 11/494,690

(22) Filed: Jul. 28, 2006

(30) Foreign Application Priority Data
Aug. 2, 2005 (JP) 2005-223896

(51) Int. Cl. G11B 7/00

(52) U.S. Cl. 369/44.29

(57) ABSTRACT

An optical disc apparatus is capable of performing at least one of recording, reproduction and erasure of information, the optical disc apparatus. An optical pickup device irradiates a light onto an optical disc and receives the light reflected by the optical disc so as to output an output signal. A servo signal detection circuit detects a focus error signal from the output signal. An automatic gain control circuit amplifies the focus error signal according to one of a plurality of gains including a previously set fixed value. A control part sets the gain of the automatic gain control circuit to the previously set fixed value when the optical disc is set to a predetermined position in the optical disc apparatus.

### BACKGROUND OF THE INVENTION

1. Field of the Invention

The present invention generally relates to optical disc apparatuses and, more particularly, to an optical disc apparatus which performs at least one of recording, reproduction and erasure of information on an optical disk.

2. Description of the Related Art

In recent years, with progress in the digital technology and improvement in data compression technology, optical discs such as a CD (compact disc) or a DVD (digital versatile disc) have drawn attention as information recording media for recording information such as music, a movie, a photograph and computer software. With price reduction thereof, an optical disc apparatus performing recording, reproduction and erasure of information on an optical disc has become popular.

Such an optical disc apparatus performs recording of information by forming a minute spot of a laser light on a recording surface of an optical disc placed at a predetermined position, and performs reproduction of information based on a reflected light from the recording surface. The optical disc apparatus has an optical pickup device which focuses a laser light on the recording surface of the optical disc and receives the reflected light from the recording surface.

Usually, the optical pickup device includes an objective lens, an optical system which guides a light emitted from a light source to the recording surface of the optical disc and guides a returning light reflected at the recording surface to a predetermined light receiving position, a photodetector which is arranged at the light receiving position, and a lens drive device which drives the objective lens in a direction of an optical axis thereof (hereinafter, may be referred to as a focusing direction). The photodetector outputs not only reproduction information of data recorded on the recording surface but also information (servo information) necessary for position control of the objective lens.

The optical disc apparatus detects a focus error signal from an output signal of the photodetector during recording and reproduction, and controls a position of the objective lens in the focusing direction by the lens drive device based on the focus error signal so that the focus error does not occur. Such a servo control may be referred to as a focus control, and is very important for performing recording and reproduction with good accuracy.

If the objective lens is moved in the focusing direction within a predetermined range, the focus error signal varies in an S-curve with a signal level (hereinafter, referred to as a focused level) corresponding to a focal position as a middle level. This signal is referred to as an S-curve signal. That is, a difference from the focus level increases as a defocus amount increases. Thus, in the focus control, the position of the objective lens is servo-controlled through the lens drive device so that the signal level of the focus error signal is substantially equal to the focused level.

Moreover, there may be a case where the output signal of the photodetector is disturbed due to defects while recording or reproducing information on an optical disc, or the signal amplitude of the output signal of the photodetector fluctuates due to a fluctuation in the light-emitting power of the light source. Thus, in order to stabilize the focus error signal, it has been suggested to use an automatic gain control circuit (hereinafter, referred to as AGC circuit), which automatically switches the gain of the focus error signal in accordance with a sum signal of the output signal of the photodetector (refer to Patent Document 1).

Patent Document: Japanese Patent No. 3545604

In the meantime, when detecting the focus error signal, if a light reflected at a surface of a protective layer (a polycarbonate layer in a general optical disc) of an optical disc is detected by the photodetector, an S-curve signal similar to the focus error signal may be generated due to a fluctuation in a reflectance at the protective layer. In such a case, the gain of the AGC circuit is erroneously set, which may result in an error in the focus control or a focus servo being erroneously performed o the protective layer.

### SUMMARY OF THE INVENTION

It is a general object of the present invention to provide an improved and useful optical disc apparatus in which the above-mentioned problems are eliminated.

A more specific object of the present invention is to provide an optical disc apparatus which is capable of performing a focus control stably with good accuracy.

In order to achieve the above-mentioned objects, there is provided according to the present invention a n optical disc apparatus capable of performing at least one of recording, reproduction and erasure of information, the optical disc apparatus comprising: an optical pickup device that irradiates a light onto an optical disc and receives the light reflected by the optical disc so as to output an output signal; a servo signal detection circuit that detects a focus error signal from the output signal; an automatic gain control circuit that amplifies the focus error signal according to one of a plurality of gains including a previously set fixed value; and a control part that sets the gain of the automatic gain control circuit to the previously set fixed value when the optical disc is set to a predetermined position in the optical disc apparatus.

According to the present invention, when the optical disc is set at the predetermined position, the focus error signal is amplified according to the previously set fixed gain. Thus, en erroneous detection that a false signal is detected as a focus error signal can be prevented by using a design value of the gain determined by simulation or a logical operation as the previously set fixed gain. As a result, a focus control can be carried out stably with good accuracy.

In the optical disc apparatus according to the present invention, when an objective lens provided in the optical pickup device is positioned at a focal position in a state where the previously set fixed value is set to the gain of the automatic gain control circuit, the control part may change the gain to a value corresponding to a sum signal generated by a plurality of signals acquired from the light reflected by the optical disc. Additionally, the automatic gain control circuit may hold the gain when a predetermined time period has passed after the gain of the automatic gain control circuit was set to the value corresponding to the sum signal. The predetermined time period may be a stabilization time of the automatic gain control circuit. Further, when the objective lens is positioned at the focal position in a state where the gain of the automatic gain control circuit is held, the control part may change the gain of the automatic gain control circuit to the value corresponding to the sum signal generated by the plurality of signals acquired from the light reflected by the optical disc.

Other objects, features and advantages of the present invention will become more apparent form the following detailed description when read in conjunction with the accompanying drawings.

### BRIEF DESCRIPTION OF THE DRAWINGS

FIG. 1 is a block diagram of an optical disc apparatus according to an embodiment of the present invention;

FIG. 2 is an illustration for explaining a light-receiver of the optical pickup device shown in FIG. 1;

FIG. 3 is an illustration for explaining an I/V amplifier shown in FIG. 1;

FIG. 4 is a block diagram of a circuit which detects a focus error signal in a servo signal detection circuit shown in FIG. 1;

FIG. 5 is an illustration for explaining an operation mode of an AGC circuit shown in FIG. 4;

FIG. 6 is a flowchart of an optimization process of the circuit which detects a focus error signal shown in FIG. 4; and

FIG. 7 is a timing chart of the optimization process shown in FIG. 6.

### DETAILED DESCRIPTION OF THE PREFERRED EMBODIMENT

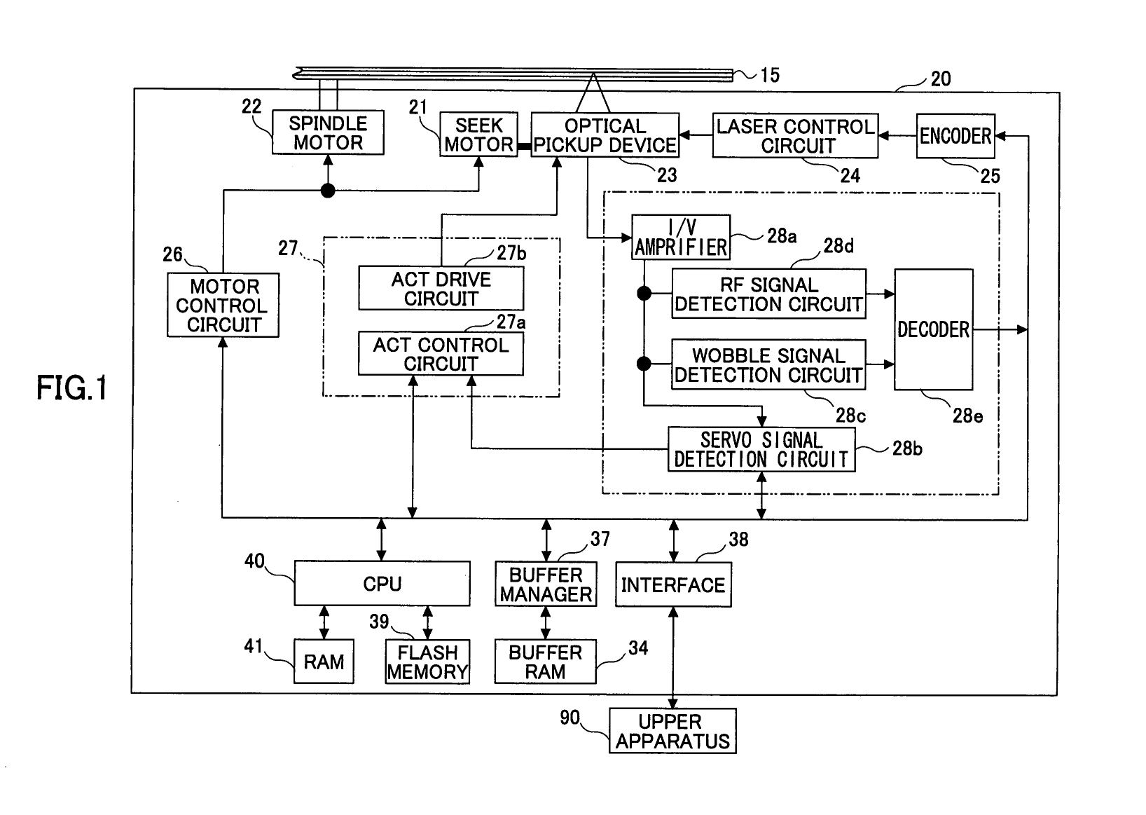

A description will now be given, with reference to the drawings, of an embodiment of the present invention. FIG. 1 shows an outline structure of an optical disc apparatus according to an embodiment of the present invention.

The optical disc apparatus 20 shown in FIG. 1 comprises a spindle motor 22 for rotationally driving an optical disc 15, an optical pickup device 23, a seek motor 21 for driving the optical pickup device 23 in a seek direction, a laser control circuit 24, an encoder 25, a motor control circuit 26, a pickup (PU) control circuit 27, a reproduction signal process circuit 28, a buffer RAM 34, a buffer manager 37, an interface 38, a flash memory 39, a CPU 40, a RAM 41, etc. It should be noted that connection lines in FIG. 1 indicate typical signal and information flow, and they do not indicate all connection relationships between the blocks. Additionally, it is assumed that the optical disc apparatus 20 is compatible with a DVD, for example.

The optical pickup apparatus 23 irradiates a laser light onto a recording surface of the optical disc 15 on which spiral or concentric tracks are formed and receives a reflected light from the recording surface. The optical pickup device 23 comprises, although not shown in the figure, a light source which emits a laser light of a wavelength of about 660 nm, an objective lens condensing the light from the light source on the recording surface, a light-receiver which receives a return light reflected by the recording surface and passed through the objective lens, a position sensor which detects a position of the objective lens, a drive system which minutely drives the objective lens, etc.

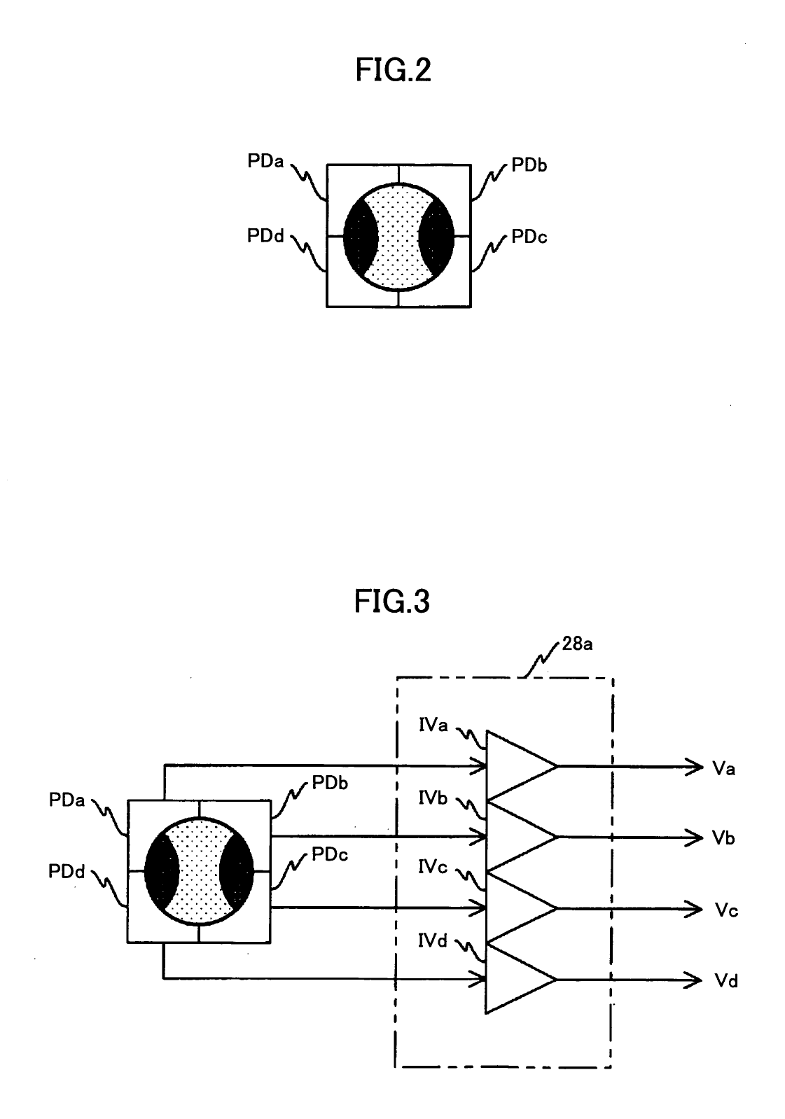

It should be noted that the light-receiver has four light-receiving areas (PDa, PDb, PDc, PDd) as shown in FIG. 2 as an example, and the light-receiving areas output signals corresponding to an amount of received lights to the reproduction signal process circuit 28, respectively.

Moreover, the drive system has a focusing actuator for driving the objective lens in a focusing direction and a tracking actuator for driving the objective lens in a tracking direction.

The reproduction signal process circuit 28 includes an I/V amplifier 28a, a servo signal detection circuit 28b, a wobble signal detection circuit 28c, an RF signal detection circuit 28d, a decoder 28e, etc.

The I/V amplifier 28a has four amplifiers (IVa, IVb, IVc, IVd), as shown in FIG. 3 as an example. The amplifier IVa converts the output signal of the light-receiving area PDa into a voltage signal and amplifies the voltage signal at a predetermined gain. The amplifier IVb converts the output signal of the light-receiving area PDb into a voltage signal and amplifies the voltage signal at a predetermined gain. The amplifier IVc converts the output signal of the light-receiving area PDc into a voltage signal and amplifies the voltage signal at a predetermined gain. The amplifier IVd converts the output signal of the light-receiving area PDd into a voltage signal and amplifies the voltage signal at a predetermined gain. It should be noted that the voltage signal output from the amplifier IVa is set to Va, the voltage signal output from the amplifier IVb is set to Vb, the voltage signal output from the amplifier IVc is set to Vc, and the voltage signal output from the amplifier IVd is set to Vd.

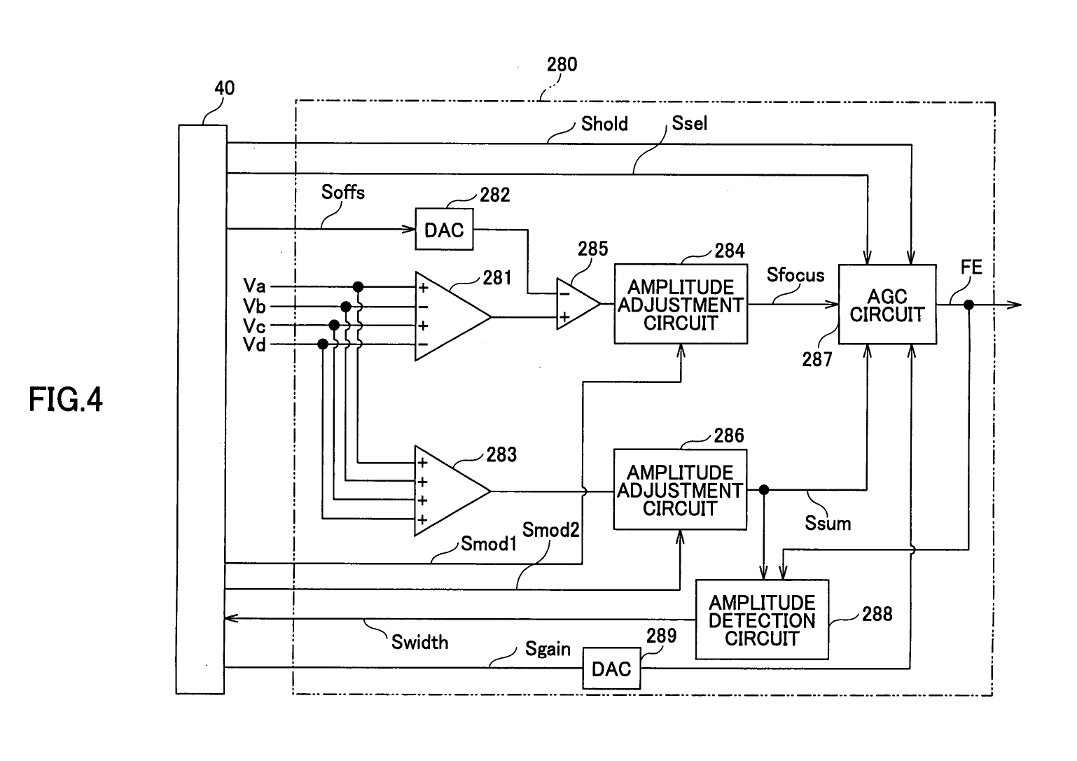

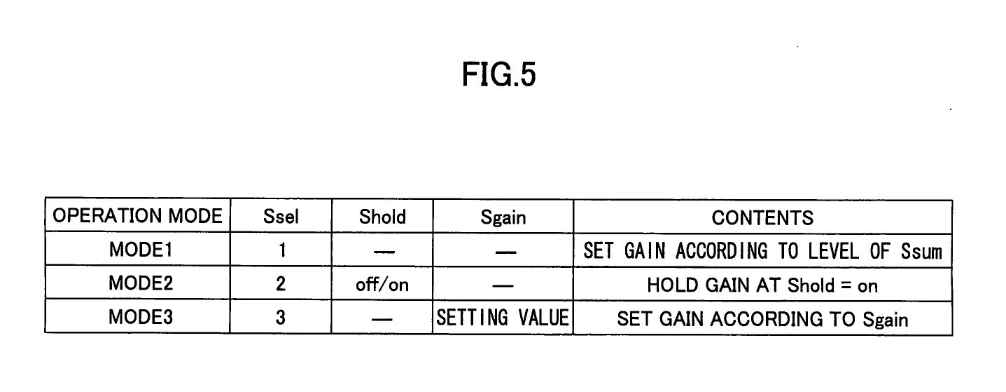

The servo signal detection circuit 28b detects servo signals such as a focus error signal and a track error signal based on the output signal of the I/V amplifier 28a. As shown in FIG. 4 as an example, the circuit 280, which detects the focus error signal in the servo signal detection circuit 28b, includes a focus error operation amplifier 281, two DA converters 282 and 289, a sum signal operation amplifier 283, two amplitude adjustment circuits 284 and 286, a differential amplifier 285, an AGC circuit 287, an amplitude detection circuit 288, etc. It should be noted that the focus error signal is to be detected according to an astigmatic method as an example.

The focus error signal operation amplifier 281 calculates (Va+Vc)−(Vb+Vd) with respect to the output signal of the I/V amplifier 28a. The DA converter 282 converts an offset removal signal Soffs from the CPU 40 into an analog signal. The differential amplifier 285 subtracts the output signal of the DA converter 282 from the output signal of the focus error signal operation amplifier 281 so as to remove an offset component contained in the output signal of the focus error signal operation amplifier 281. The sum signal operation amplifier 283 performs an operation (Va+Vb+Vc+Vd) on the output signal of the I/V amplifier 28a. The amplitude adjustment circuit 284 adjusts the amplitude of the output signal of the differential amplifier 285 in accordance with a gain setting signal Smod1 from the CPU 40. The amplitude adjustment circuit 286 adjusts the amplitude of the output signal of the sum signal operation amplifier 283 in accordance with a gain setting signal Smod2 from the CPU 40.

The amplitude detection circuit 288 detects the amplitude of the output signal (focus error signal) FE of the AGC circuit 287 and the amplitude of the output signal Ssum of the amplitude adjustment circuit 286, respectively, and notifies the CPU 40 of the detected amplitudes as a detection signal Swidth. The DA converter 289 converts the gain setting signal Sgain from the CPU 40 into an analog signal.

The AGC circuit 287 amplifies and normalizes the output signal Sfocus of the amplitude adjustment circuit 284 based on the output signal Ssum of the amplitude adjustment circuit 286, the output signal of the DA converter 289, the circuit operation selection signal Ssel and the AGC hold signal Shold, and outputs the signal Sfocus to the servo control circuit 27 as the focus error signal FE. In the present embodiment, as an example, the operation of the AGC circuit 287 includes three modes (mode 1, mode 2, mode 3) so that one of the modes can be selected by the CPU 40 (refer to FIG. 5).

The mode 1 corresponds to Ssel=1. According to the mode 1, the gain of the AGC circuit 287 is set up so that the output signal Ssum of the amplitude adjustment circuit 286 is at a previously set signal level, similar to an operation of a regular AGC circuit. The mode 2 corresponds to Ssel=2. According to the mode 2, when the AGC hold signal Shold is ON, the gain at that time is held irrespective of the output signal Ssum of the amplitude adjustment circuit 286. The mode 3 corresponds to Ssel=3. According to the mode 3, a gain designated by a gain setting signal Sgain is set up.

It should be noted that the CPU 40 and parts of the circuit 280 other than the AGC circuit 287 may serve as a control part that control the gain of the AGC circuit 287.

Returning to FIG. 1, the wobble signal detection circuit 28c detects a wobble signal based on the output signal of the I/V amplifier 28a. The RF signal detection circuit 28d detects an RF signal based on the output signal of the I/V amplifier 28a. The decoder 28e extracts address information, a synchronization signal, etc., from the wobble signal. The address information is used for positioning. A reproduction clock signal and a recording clock signal are generated from the synchronization signal.

Moreover, the decoder 28e performs a decoding process and an error detection process on the RF signal, and performs an error correction process when an error is detected, and, thereafter, stores the RF signal as reproduction data in the buffer RAM 34 through the buffer manager 37. Then, the reproduction data is transferred to an upper apparatus 90 from the buffer RAM 34 through the interface 38.

The PU control circuit 27 includes an ACT control circuit 27a, an ACT drive circuit 27b, etc. The ACT control circuit 27a generates a control signal of the focusing actuator for correcting a focus offset based on the focus error signal, when the focus control is turned on, and generates a control signal of the focusing actuator for correcting a tracking offset based on the tracking error signal, when the tracking control is turned on. The ACT control circuit 27a generates a control signal of the focusing actuator based on an instruction from the CPU 40. It should be noted that the focus control and the tracking control are turned on or off by the CPU 40. The ACT drive circuit 27b generates a drive signal of each actuator of the optical pickup device 23 in accordance with each control signal from the ACT control circuit 27a, and outputs the drive signal to the optical pickup device 23.

The motor control circuit 26 carries out drive control of the spindle motor 22 and the seek motor 21 based on instructions from the CPU 40, respectively. A piece of data (recording data) to be recorded on the optical disc 15 and a piece of data (reproduction data) reproduced from the optical disc 15 are temporarily stored in the buffer RAM 34. Input and output of the data to and from the buffer RAM 34 are managed by the buffer manager 37. Based on instructions from the CPU 40, the encoder 25 retrieves the recording data stored in the buffer RAM 34 through the buffer manager 37, modulates the retrieved data and adds an error correction code to the data, and generates a write signal to the optical disc 15. The laser control circuit 24 controls a power of the laser light emitted from the light source of the optical pickup device 23. For example, when performing recording, a drive signal of the light source is generated based on the above-mentioned write signal, a recording condition and a light-emitting characteristic of the light source. The interface 38 is a bidirectional communication interface with the upper apparatus (for example, a personal computer) 90, and conforms to a standard interface such as ATAPI (AT Attachment Packet Interface), SCSI (Small Computer System Interface) and USB (Universal Serial Bus).

Various kinds of programs described in code and decipherable by the CPU 40, information regarding recording conditions and light-emitting characteristic are stored in the flash memory 39. The CPU 40 controls the above-mentioned parts according to the programs stored in the flash memory 39, and saves data necessary for the control in the RAM 41.

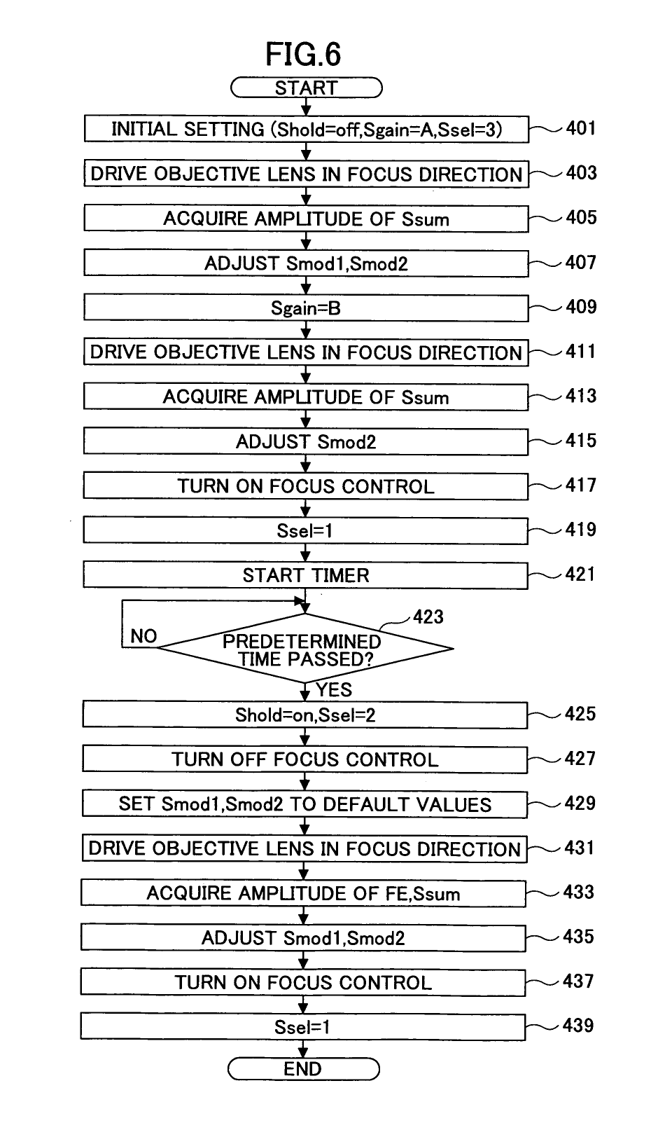

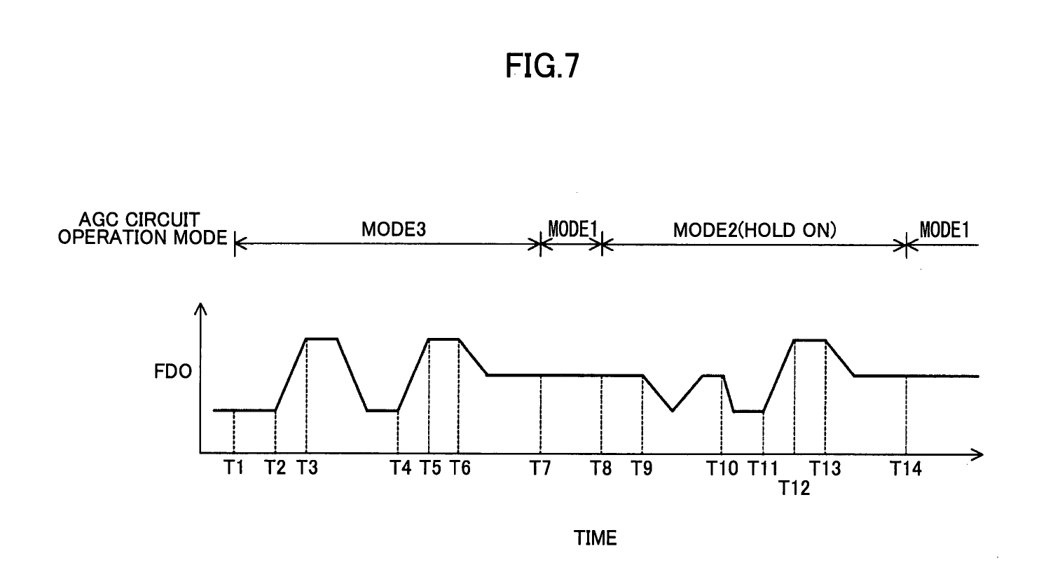

A description will now be given, with reference to FIG. 6 and FIG. 7, of an optimization process of the circuit 280, which detects the focus error signal, in the optical disc apparatus 20 having the above-mentioned structure. The flowchart of FIG. 6 corresponds to a series of process algorithm performed by the CPU 40. Moreover, “FDO” shown in FIG. 7 indicates the drive signal of the focusing actuator output from the ACT drive circuit 27b.

The optical disc 15 is set to a predetermined position in the optical disc apparatus 20, and when optimization of the circuit 280, which detects the focus error signal, is needed, a head address of the program corresponding to the flowchart of FIG. 6 stored in the flash memory 39 is set in a program counter of the CPU 40, and the optimization process is started.

In step 401, an initialization of various relevant settings is performed (T1 in FIG. 7). At this time, it is set as Shold=off, Sgain=A (default value), and Ssel=3. That is, the operation mode of the AGC circuit 287 is set to the mode 3. Additionally, default values are set also to Smode1 and Smode2. In the subsequent step 403, the objective lens is moved in a focusing direction within a predetermined range having a predetermined reference position as a center (T2-T3 in FIG. 7). Then, in step 405, an amplitude of the signal Ssum is acquired through the amplitude detection circuit 288. Here, the amplitude can be acquired accurately without mistaking as a false S-curve signal generated at a surface of the optical disc 15 since the gain of the AGC circuit 287 is a default gain (here, a gain A).

Then, in step 407, the gain setting signal Smod2 is adjusted so that the signal Ssum has a predetermined amplitude. Additionally, the gain setting signal Smod1 is also adjusted accordingly. In step 409, the signal Sgain is adjusted according to the amplitude of the signal Ssum. Here, it is assumed that Sgain=B.

In the subsequent step 411, the objective lens is moved again in the focusing direction within the above-mentioned range through the PU control circuit 27(T4-T5 in FIG. 7). Then, in step 413, the amplitude of the signal Ssum is acquired through the amplitude detection circuit 288. Here, a pull-in of focus serve can be carried out accurately without mistaking as a false S-curve signal generated at a surface of the optical disc 15 since the gain of the AGC circuit 287 is the default gain (here, a gain B). In step 415, the gain setting signal Smod2 is adjusted so that the signal Ssum has a predetermined amplitude.

In the subsequent step 417, the focus control is turned on so as to start the pull-in of focus (T6 in FIG. 7). Here, the pull-in of focus can be carried out accurately without mistaking as a false S-curve signal generated at a surface of the optical disc 15 since the gain of the AGC circuit 287 is the default gain (here, the gain B).

Then, in step 419, it is set as Ssel=1 (T7 in FIG. 7). That is, the operation mode of the AGC circuit 287 is changed into the mode 1. In step 421, the timer is started. Thereby, a count value of the timer is incremented by an interruption process generated at each predetermined time. Then, in step 423, a time at which the count value of the timer reaches a predetermined value is waited for, that is, it is determined whether or not a p predetermined time has passed. When the count value of the timer reaches the predetermined value, the determination in step 423 becomes affirmative, and the routine proceeds to step 425 (T8 in FIG. 7). It should be noted that a value corresponding to a time slightly longer a stabilization time of the AGC circuit 287 is set to the above-mentioned predetermined value.

In the subsequent step 425, it is set as Shold=on and Ssel=2. That is, the operation mode of the AGC circuit 287 is changed into the mode 2. Then, in step 427, the focus control is turned off so as to defocus the light (T9 in FIG. 7). In the subsequent step 429, the gain setting signal Smod1 and the gain setting signal Smod2 are changed into the default values (T10 in FIG. 7). Then, in step 431, the objective lens is moved in the focusing direction within the above-mentioned range through the PU control circuit 27 (T11-T12 in FIG. 7).

In the subsequent step 433, the amplitude of the signal FE and the amplitude of the signal Ssum are acquired through the amplitude detection circuit 288, respectively. Then, in step 435, the gain setting signal Smod1 and the gain setting signal Smod2 are adjusted so that the signal FE and the signal Ssum have predetermined amplitudes, respectively. In step 437, the focus control is turned on so as to start pull-in of focus (T13 in FIG. 7). In step 439, it is set as Ssel=1(T14 in FIG. 7). That is, the operation mode of the AGC circuit 287 is changed into the mode 1, and, then, the optimization process is completed.

As explained above, in the optical disc apparatus 20 according to the present embodiment, when the optical disc 15 is set at the predetermined position, the mode 3 is directed to the AGC circuit 287. Here, the gain of the AGC circuit 287 is set to a fixed value irrespective of the signal level of the signal Ssum, and the signal generated by the focus error signal operation amplifier 281 is amplified by the AGC circuit 287 with the default gain (previously set fixed value) based on the output signal of a plurality of light-receiving areas of the light-receiver. Thereby, the circuit, which detects the focus error signal, can be prevented from erroneously detecting a false signal as the focus error signal. Therefore, it becomes possible to perform the focus servo stably with good accuracy.

Then, when the objective lens is positioned at a focal position, the mode 1 is directed to the AGC circuit 287, and when a time slightly longer than the stabilization time of the AGC circuit 287 has passed, the mode 2 is directed to the AGC circuit 287. Accordingly, a more appropriate gain can be set in the AGC circuit 287.

Furthermore, in the state where the gain of the AGC circuit 287 is held, the focus control is turned on after the amplitude of the signal Sfocus and the amplitude of the signal Ssum are optimized by the amplitude adjustment circuit 284. Then, when the objective lens is positioned at a focal position, the mode 1 is directed to the AGC circuit 287. That is, since the optimized signals Sfocus and Ssum are input to the AGC circuit 287, the gain of the AGC circuit 287 can be prevented from being set to an abnormal value.

Moreover, if the gain of the AGC circuit 287 can be selected from a plurality of gains, the gain setting signal Sgain may be a selection signal, which selects one of the plurality of gains.

It should be noted that the I/V amplifier 28a in the above-mentioned embodiment may be provided in the optical pickup device 23. In such a case, at least one of the focus error signal operation amplifier 281 and the sum signal operation amplifier 283 may be provided in the optical pickup device 23.

Moreover, although the case where the circuit 280, which detects the focus error signal, is an analog signal circuit was explained in the above-mentioned embodiment, the present invention is not limited to such a case, and circuit 280 may be a digital circuit. What is necessary is to be able to prevent erroneously recognizing a false signal as the focus error signal.

Moreover, although the optical disc apparatus capable of recording and reproduction of information was explained in the above-mentioned embodiment, the present invention is not limited to such an apparatus, and is applicable to an optical disc apparatus which is capable of performing at least one of recording, reproduction and erasure of information.

Moreover, although the case where optical pickup device has a single semiconductor laser in the above-mentioned embodiment, the present invention is not limited to such a case, and is applicable to a case where the optical pickup apparatus has a plurality of semiconductor lasers that emit light beams having different wavelengths to each other. In such a case, for example, at least one of a semiconductor laser generating a light beam having a wavelength of about 660 nm and a semiconductor laser generating a light beam having a wavelength of about 780 nm may be provided. That is, the optical disc apparatus may compatible with a plurality of kinds of optical discs that conform to different standards.

Moreover, although the case where a single recording layer is provided in the optical disc in the above-mentioned embodiment, a so-called single-sided multi-layer disc may be used. Moreover, a DVD player or a DVD recorder may be used as the optical disc apparatus.

The present invention is not limited to the specifically disclosed embodiment, and variations and modifications may be made without departing from the scope of the present invention.

The present application is based on Japanese priority application No. 2005-223896 filed Aug. 2, 2006, the entire contents of which are hereby incorporated herein by reference.

What is claimed is:

1. An optical disc apparatus capable of performing at least one of recording, reproduction and erasure of information, the optical disc apparatus comprising:
an optical pickup device that irradiates a light onto an optical disc and receives the light reflected by the optical disc so as to output an output signal;
a servo signal detection circuit that detects a focus error signal from the output signal;
an automatic gain control circuit that amplifies the focus error signal according to one of a plurality of gains including a previously set fixed value; and
a control part that sets the gain of the automatic gain control circuit to the previously set fixed value when the optical disc is set to a predetermined position in the optical disc apparatus.

2. The optical disc apparatus as claimed in claim 1, wherein, when an objective lens provided in said optical pickup device is positioned at a focal position in a state where the previously set fixed value is set to the gain of said automatic gain control circuit, said control part changes the gain to a value corresponding to a sum signal generated by a plurality of signals acquired from the light reflected by the optical disc.

3. The optical disc apparatus as claimed in claim 2, wherein said automatic gain control circuit holds the gain when a predetermined time period has passed after the gain of said automatic gain control circuit was set to the value corresponding to the sum signal.

4. The optical disc apparatus as claimed in claim 3, wherein, when said objective lens is positioned at the focal position in a state where the gain of said automatic gain control circuit is held, the control part changes the gain of said automatic gain control circuit to the value corresponding to the sum signal generated by the plurality of signals acquired from the light reflected by the optical disc.

5. The optical disc apparatus as claimed in claim 3, wherein the predetermined time period is a stabilization time of said automatic gain control circuit.

6. The optical disc apparatus as claimed in claim 5, wherein, when said objective lens is positioned at the focal position in a state where the gain of said automatic gain control circuit is held, the control part changes the gain of said automatic gain control circuit to the value corresponding to the sum signal generated by the plurality of signals acquired from the light reflected by the optical disc.
